(19) United States
(12) Patent Application Publication
(10) Pub. No.: US 2026/0097659 A1
(43) Pub. Date: Apr. 9, 2026

(54) Power Supply Device, Power Supply Arrangement, Vehicle and Return Method

(71) Applicant: Siemens Mobility Austria GmbH, Wien (AT)

(72) Inventors: Christian SALIGER, Wien (AT); Georg HAVLICEK, Wien (AT)

(21) Appl. No.: 19/112,310

(22) PCT Filed: Sep. 18, 2023
(86) PCT No.: PCT/EP2023/075574

§ 371 Date: Mar. 17, 2025

(30) Foreign Application Priority Data
Sep. 19, 2022 (AT) A50721/2022

(51) Int. Cl. B60L 5/16; B60L 5/19; B60L 5/30; B60L 5/42; B60L 53/16

(52) U.S. Cl. CPC B60L 5/16; B60L 5/19; B60L 5/30; B60L 5/42; B60L 53/16; B60L 2200/18; B60L 2200/40

(57) ABSTRACT

A power supply device for a vehicle, in particular for a utility vehicle such as an electric bus or an electric heavy goods vehicle, includes at least one contact head that can be brought in contact with a docking apparatus to establish an electrical connection, and includes at least a first pivot arm that is connected to the at least one contact head and can be rotatably connected to a vehicle, and includes a return apparatus, where the return apparatus is formed, as a driver with respect to the at least one first pivot arm, to be placable on the at least first pivot arm and removable from the at least first pivot arm such that a safe return of the first pivot arm is ensured.

### CROSS-REFERENCE TO RELATED APPLICATIONS

This is a U.S. national stage of application No. PCT/EP2023/075574 filed 18 Sep. 2023. Priority is claimed on Austrian Application No. A50721/2022 filed 19 Sep. 2022, the content of which is incorporated herein by reference in its entirety.

### BACKGROUND OF THE INVENTION

### 1. Field of the Invention

The invention relates to a power supply facility for a vehicle, in particular for a utility vehicle such as an electric bus or an electric truck, with at least one contact head, which can be brought into contact with a docking apparatus in order to form an electrical connection, with at least one first pivot arm that is connected to the at least one contact head and can be rotatably connected to a vehicle, and with a return apparatus.

### 2. Description of the Related Art

Power supply facilities with contact heads can be brought into contact with docking apparatuses (for example contact hoods of charging columns of a vehicle infrastructure). Electrical connections between the contact heads and the docking apparatuses result in the contact heads being supplied with electricity. The contact heads are frequently connected via linkages or pivot arms to roofs of vehicles (for example electric buses or trucks), as a result of which current can be collected via the docking apparatuses and a power supply of the vehicles via the linkages. Thus, for example, batteries or accumulators of the vehicles can be charged (for example, in a bus or truck depot or at a bus stop).

It is important to return the contact heads from deflected positions in a repeatable and reliable manner into their initial positions after contacting processes, so that contacting processes can occur anew from defined positions of the contact heads.

DE 10 2012 202 955 A1, for example, describes a charging current collector via which an energy store of an electric vehicle can be charged via a current transmitted by a stationary charging station. A platform with electrical contacts is coupled to a current collector linkage. The current collector linkage is connected to the vehicle.

EP 3 031 104 B1 furthermore discloses a charging system for electric vehicles, in which a contact apparatus and a bearing apparatus for the contact apparatus are connected to a vehicle. The contact apparatus can be brought into contact with a charging contact unit of a stationary charging station. The contact apparatus comprises a contact facility that can be guided via a positioning facility from a contact position on the charging contact unit into a storage position on the bearing apparatus. The bearing apparatus forms a receiving opening with a guide facility, via which the contact facility can be positioned in the storage position.

### SUMMARY OF THE INVENTION

It is an object of the invention to provide a power supply facility, which is developed in relation to the prior art, with a structurally simple, compact and robust return apparatus.

This and other objects and advantages are achieved in accordance with the invention by a power supply facility in which the return apparatus, formed as a driver with respect to the at least first pivot arm, can be applied to the at least first pivot arm and can be removed from the at least first pivot arm.

This makes it possible to dispense with structurally complex and large bearing apparatuses for mounting the first pivot arm (for example, on a vehicle roof) in a lowered position. The return apparatus is not very susceptible to contamination and weather influences (for example, icing-up), which is why reliable operation of the power supply facility is possible even under adverse operating conditions.

It is helpful, for example, if the return apparatus has a bow-shaped or hook-shaped configuration. This measure makes secure mechanical contacting of the return apparatus with the first pivot arm possible.

A preferred solution is obtained if the return apparatus has a first leg and a second leg, which are oriented towards one another in an inclined manner.

The return apparatus can be formed, for example, in a V-shape with a rounded transition section between the first leg and the second leg of the V-shape. This simplifies centering of the first pivot arm in the return apparatus.

It can also be advantageous if the at least first pivot arm can be connected to a vehicle so as to be rotatable about a parallel to a power supply facility transverse axis and about a normal to the parallel to the power supply facility transverse axis. As a result of this measure, the first pivot arm can execute first rotational movements about the parallel to the power supply facility transverse axis and second rotational movements about the normal to the parallel to the power supply facility transverse axis. With the first rotational movements, the contact head can, for example, be raised and, for example, delivered to a docking apparatus and, with the second rotational movement, can be oriented, for example, transversely to a vehicle until a position suitable for current transmission to the docking apparatus is reached. With the second rotational movements, the contact head can execute a translational movement without a translational relative movement between the contact head and the first pivot arm being required for this purpose. It is possible to dispense with guide rails, and/or sliding bearings between the contact head and the first pivot arm.

A precise alignment of the contact head, for example, in or on the docking apparatus, is consequently achieved. To secure the contact head against twisting relative to the first pivot arm, a guide apparatus, for example, can be connected in an articulated manner to the at least one contact head and can be connected in an articulated manner to a vehicle, where it is possible for the contact head to be connected, for example, in an articulated manner to the first pivot arm.

A simple kinematics for return processes of the first pivot arm is achieved if the return apparatus can be connected to a vehicle so as to be rotatable about a parallel to a power supply facility transverse axis. For example, a return rotary drive or an actuator with a cylinder and a piston, the actuator force of which is transmitted to the return apparatus via a force-torque converter, etc., can be coupled to the return apparatus.

It can also be helpful if the return apparatus can be connected to a vehicle so as to be displaceable in the direction of a power supply facility longitudinal axis and/or in the direction of a power supply facility vertical axis. As a result, when, for example, a linear drive is coupled to the return apparatus and when the return apparatus carries out exclusively translational movements, it is possible to dispense with a force-torque converter for converting translational movements into rotational movements between the linear drive and the return apparatus.

Particularly safe operating conditions of the power supply facility are achieved if the return apparatus is coupled to its own return drive.

The return drive can be formed, for example, as a pneumatic actuator with a cylinder and a piston or as an electric linear actuator that is retracted or extended as a function of control signals to move the return apparatus. For example, the return drive can be moved between two limit positions. A first limit position can correspond, for example, to a lowered and centered position of the first pivot arm, a second limit position, for example, to a fully deflected position of the first pivot arm, in which the first pivot arm is spaced apart from the return apparatus and in which movements of the first pivot arm are not influenced by the return apparatus.

The first limit position and the second limit position can be reported back, for example, by limit position switches in the return drive itself or by external sensors or limit position switches, etc.

The return drive can have, for example, a securing apparatus (for example, a holding brake), via which, for example, the first limit position and the second limit position of the return drive can be fixed.

An advantageous embodiment is obtained if at least one sliding element or a sliding layer is arranged between the at least first pivot arm and the return apparatus. Here, positioning of the first pivot arm relative to the return apparatus can be performed with high accuracy if the at least one sliding element or the sliding layer is formed as a centering apparatus for the at least first pivot arm.

Wear in a mechanical contact between the first pivot arm and the return apparatus is reduced and a smooth guidance of the first pivot arm by the return apparatus is made possible if at least one roller or at least one roll is arranged between the at least first pivot arm and the return apparatus. In this context, positioning of the first pivot arm relative to the return apparatus can be carried out with high accuracy if the at least one roller or the at least one cylinder is formed as a centering apparatus for the at least first pivot arm.

It is advantageous if at least one first return spring is connected to the return apparatus in order to generate a spring force via which the at least first pivot arm can be automatically guided in the direction of a vehicle. As a result of this measure, the first pivot arm can, for example, also be transferred into a lowered position in the event of a defect or a failure of the return drive.

A promising field of application for the power supply facility is opened up with a power supply arrangement for a vehicle, in particular for a utility vehicle such as an electric bus or an electric truck, with at least one power supply facility and with at least one stationary electrical charging apparatus comprising at least one docking apparatus, with which the at least one power supply facility can be brought into contact with electricity in order to form an electrical connection and for supplying the at least one power supply facility.

The power supply facility can be connected, for example, to a vehicle (for example, to a vehicle roof). The stationary charging apparatus can be, for example, part of a bus stop, a vehicle depot, a maintenance stand, and/or a parking facility and can be connected to an electricity supply network.

A significant field of application for the power supply facility is furthermore opened up with a vehicle, in particular a utility vehicle, such as an electric bus or electric truck, with at least one power supply facility.

A return and positioning process, which is reliable and precise even under adverse operating conditions, is made possible by a method for returning a first pivot arm, with which a contact head is connected to a current collector for a vehicle, in particular for a utility vehicle such as an electric bus or an electric truck, where the current collector comprises a return apparatus, in which, starting from a deflected first state of the first pivot arm, in which the return apparatus is spaced apart from the first pivot arm, the return apparatus is pressed against the first pivot arm and the first pivot arm in guided into a lowered and centered second state of the first pivot arm, where the return apparatus is pressed against the first pivot arm in the second state. In the first state, in which the first pivot arm can, for example, contact a docking apparatus of a stationary, electrical charging apparatus via a contact head, the mobility of the first pivot arm is unaffected by the return apparatus. In the second state, the first pivot arm is held in a lowered and centered position.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained in more detail below on the basis of exemplary embodiments, in which:

FIG. 1 shows an oblique elevation of an exemplary first embodiment of an inventive power supply facility with a first pivot arm, a contact head and a return apparatus;

FIG. 2 shows a schematic side elevation of an exemplary second embodiment of an inventive power supply facility in a lowered position with a first pivot arm, a contact head and a rotatably mounted return apparatus;

FIG. 3 shows a schematic side elevation of an exemplary third embodiment of an inventive power supply facility in a deflected position with a first pivot arm, a contact head and a rotatably mounted return apparatus, which, together with an exemplary electrical, stationary charging apparatus, forms an exemplary embodiment of an inventive power supply arrangement ;

FIG. 4 shows a schematic side elevation of the exemplary third embodiment of the inventive power supply facility in a lowered position;

FIG. 5 shows a schematic side elevation of an exemplary fourth embodiment of an inventive power supply facility in a deflected position with a first pivot arm, a contact head and a return apparatus displaceably mounted in the direction of a power supply facility vertical axis;

FIG. 6 shows a schematic side elevation of the exemplary fourth embodiment of the inventive power supply facility in a lowered position;

FIG. 7 shows a schematic side elevation of an exemplary fifth embodiment of an inventive power supply facility in a deflected position with a first pivot arm, a contact head and a return apparatus displaceably mounted in the direction of a power supply facility longitudinal axis;

FIG. 8 shows a schematic side elevation of the exemplary fifth embodiment variant of the inventive power supply facility in a lowered position;

FIG. 9 to FIG. 11 show schematic representations of different relative positions of a first pivot arm and a return apparatus of an exemplary sixth embodiment of an inventive power supply facility, with cross-sections of the first pivot arm being shown;

FIG. 12 to FIG. 14 show schematic representations of different relative positions of a first pivot arm and a return apparatus of an exemplary seventh embodiment of an inventive power supply facility;

FIG. 15 shows a schematic detail from an exemplary eighth embodiment of an inventive power supply facility, in which a sliding element is arranged between a first pivot arm and a second pivot arm, on the one hand, and a return apparatus on the other hand;

FIG. 16 shows a schematic detail from an exemplary ninth embodiment of an inventive power supply facility, in which a sliding element is arranged between a first pivot arm and a second pivot arm, on the one hand, and a return apparatus on the other hand;

FIG. 17 shows a schematic detail from an exemplary tenth embodiment of an inventive power supply facility, in which a sliding element formed as a centering apparatus is arranged between a first pivot arm and a return apparatus;

FIG. 18 shows a schematic detail from an exemplary eleventh embodiment of an inventive power supply facility, in which a roller is arranged between a first pivot arm and a second pivot arm, on the one hand, and a return apparatus on the other o hand;

FIG. 19 shows a schematic detail from an exemplary twelfth embodiment of an inventive power supply facility, in which a roller is arranged between a first pivot arm and a second pivot arm, on the one hand, and a return apparatus on the other hand,

FIG. 20 shows a schematic detail from an exemplary thirteenth embodiment of an inventive power supply facility, in which a roller formed as a centering apparatus is arranged between a first pivot arm and a return apparatus;

FIG. 21 shows a schematic detail from an exemplary fourteenth embodiment of an inventive power supply facility, in which a roller connected rotatably to a circumference of the first pivot arm is arranged between a first pivot arm and a return apparatus;

FIG. 22 shows a schematic detail from an exemplary fifteenth embodiment of an inventive power supply facility, in which a roller, which rotatably surrounds the first pivot arm, is arranged between a first pivot arm and a return apparatus;

FIG. 23 shows a schematic detail from an exemplary sixteenth embodiment of an inventive power supply facility, in which a roller is arranged between a first pivot arm and a return apparatus so as to rotatably surround the first pivot arm, with the first pivot arm being spaced apart from the return apparatus in a first state of the power supply facility, and the first pivot arm contacting the return apparatus and being centered with respect to the return apparatus in a second state of the power supply facility; and

FIG. 24 shows a flowchart for an exemplary embodiment of an inventive method for returning a first pivot arm of a current collector.

### DETAILED DESCRIPTION OF THE EXEMPLARY EMBODIMENTS

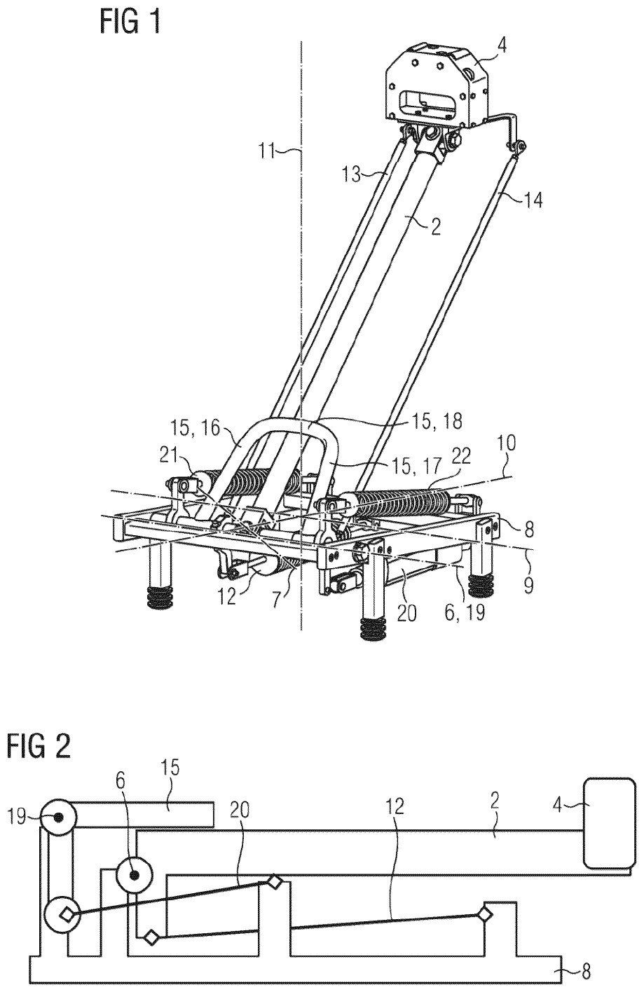

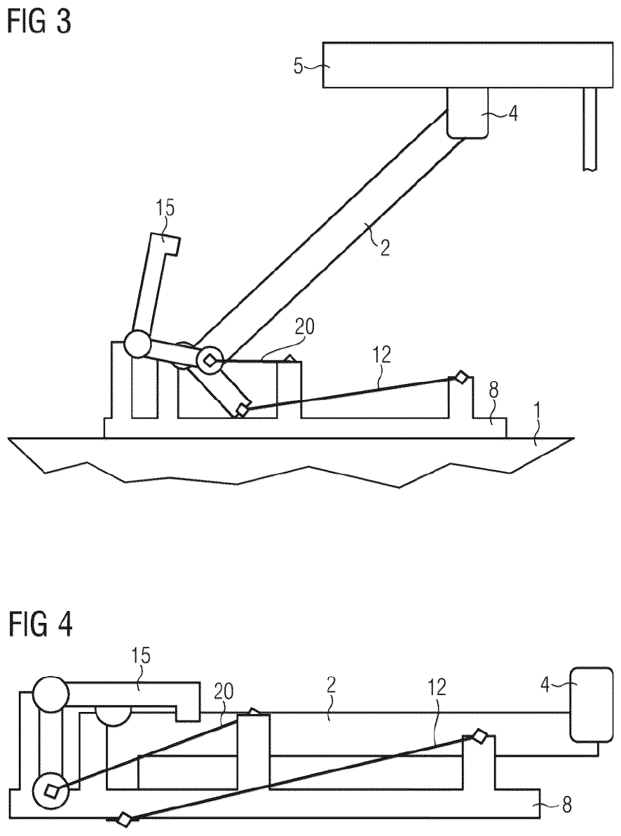

A schematic elevation represented in FIG. 1 shows an exemplary first embodiment of an inventive power supply facility that is configured as a charging current collector of an electric vehicle 1, as is illustrated, by way of example, in FIG. 3 and which is formed as a bus, i.e., a utility vehicle. Inventively, it is also conceivable that the power supply facility is provided for an electric truck etc.

The power supply facility has a first pivot arm 2 with which a contact head 4 of the power supply facility is connected in an articulated manner. The contact head 4 can be brought into contact with a docking apparatus 5 of a stationary electrical charging apparatus, as shown, by way of example, in FIG. 3, in order to form an electrical connection.

The first pivot arm 2 is mounted so as to be rotatable about a first axis of rotation 6 and a second axis of rotation 7 on a base 8 of the power supply facility formed as a metallic base frame. The base 8 is in turn permanently connected to a roof of the vehicle 1. The first axis of rotation 6 is oriented parallel to a power supply facility transverse axis 9, with the power supply facility transverse axis 9 in turn being oriented parallel to a vehicle transverse axis (not shown). The second axis of rotation 7 is oriented normal to the first axis of rotation 6 and rotates with rotational movements of the first pivot arm 2 about the first axis of rotation 6. In the deflection state of the first pivot arm 2 shown in FIG. 1, the second axis of rotation 7 is arranged in a first plane parallel to a second plane formed by a power supply facility longitudinal axis 10 and a power supply facility vertical axis 11.

Connected to the first pivot arm 2 is a pneumatic lifting drive 12 that comprises a helical spring that can be subjected to stress. The lifting drive 12 generates a lifting torque via which the first pivot arm 2 is deflected and the contact head 4 can be brought into contact with the docking apparatus 5 by movement in the direction of the power supply facility vertical axis 11.

A first guide rod 13 and a second guide rod 14 of a guide apparatus of the power supply facility are arranged parallel to the first pivot arm 2 and are connected in an articulated manner to the base 8 and in an articulated manner to the contact head 4, as a result of which unintentional tilting movements of the contact head 4 are avoided.

The power supply facility furthermore has a return apparatus 15 that can be applied as a driver with respect to the first pivot arm 2 to the at least first pivot arm 2 and can be removed from the at least first pivot arm 2.

The return apparatus 15 has a bow-shaped and approximately V-shaped configuration and has a first leg 16 and a second leg 17, which are oriented towards one another in an inclined manner, and a transition section 18 between the first leg 16 and the second leg 17.

The return apparatus 15 is connected to the base 8 via the first leg 16 and the second leg 17 so as to be rotatable about a return axis of rotation 19. The first axis of rotation 6 and the return axis of rotation 19 run into one another. However, the return apparatus 15 is rotatably mounted independently of the first pivot arm 2. The return apparatus 15 is thus connected to the vehicle 1 so as to be rotatable about a parallel to the power supply facility transverse axis 9.

The transition section 18 is curved multiple times and functions as a centering receptacle for the first pivot arm 2.

The return apparatus 15 is coupled to its own return drive 20 that is configured as an electric linear actuator with a cylinder. Linear movements of the linear actuator are converted via a lever and joints into rotational movements of the return apparatus 15 about the return axis of rotation 19. In order to fix limit positions, the return drive 20 has a holding brake which is not visible in FIG. 1.

A first return spring 21 and a second return spring 22 for generating spring forces, via which the first pivot arm 2 can be guided automatically in the direction of the base 8 and the vehicle 1, are connected to the return apparatus 15. The first return spring 21 is connected to the first leg 16, the second return spring 22 is connected to the second leg 17.

Automatic lowering of the first pivot arm 2 is possible, for example, in the event of a failure of a power supply of the return drive 20. For this purpose, the return drive 20 is formed as a non-self-locking drive.

The holding brake of the return drive 20 is configured such that it locks the return drive 20 against the first return spring 21 and the second return spring 22, which act on the return apparatus 15, when the return drive 20 is not energized, but presence of a supply voltage of the return drive 20.

When the first pivot arm 2 is automatically lowered, a torque is generated by the first return spring 21 and the second return spring 22, which torque firstly overcomes the lifting torque exerted by the lifting drive 12 via the first pivot arm 2 against the return apparatus 15 and, secondly, also an internal friction of the linear actuator.

The cylinder of the return drive 20 is extended or retracted as a function of control signals in order to move the return apparatus 15 relative to the base 8 between a first limit position and a second limit position.

A first limit position corresponds to a lowered and centered position of the first pivot arm 2, and a second limit position corresponds to a fully deflected position of the first pivot arm 2, in which the first pivot arm 2 is spaced apart from the return apparatus 15 and in which movements of the first pivot arm 2 are not influenced by the return apparatus 15. The first limit position and the second limit position are reported back by limit position switches in the return drive 20 for control and monitoring processes.

When the first pivot arm 2 and the return apparatus 15 remain in the first limit position, or during a movement of the first pivot arm 2 and the return apparatus 15 out of the second limit position into the first limit position when the return apparatus 15 rests against the first pivot arm 2, a return torque generated by the return drive 20 acting on the return apparatus 15 is greater in magnitude than the lifting torque of the lifting drive 12 opposed to the return torque. As a result, the return apparatus 15 prevents or restricts any movement of the first pivot arm 2 in the direction of the fully deflected position of the first pivot arm 2.

FIG. 2 shows a schematic side elevation of an exemplary second embodiment of an inventive power supply facility in a lowered position with a first pivot arm 2, a contact head 4 and a rotatably mounted return apparatus 15. This exemplary second embodiment is similar to the exemplary first embodiment of an inventive power supply facility, as shown in FIG. 1. Therefore, the same reference numerals as in FIG. 1 are used in FIG. 2.

In contrast to FIG. 1, the first pivot arm 2 and the return apparatus 15 according to FIG. 2 have parallel but spaced-apart rotational axes. The first pivot arm 2 has a first axis of rotation 6, the return apparatus 15 has a return axis of rotation 19, which appear to be projected in FIG. 1.

FIG. 3 shows a schematic side elevation of an exemplary third embodiment of an inventive power supply facility in a deflected position with a first pivot arm 2, a contact head 4 and a rotatably mounted return apparatus 15 which, together with an exemplary electrical, stationary charging apparatus, forms an exemplary embodiment of an inventive power supply arrangement. The charging apparatus is arranged at a stop for a vehicle 1 configured as an electric bus and has a docking apparatus 5, which is contacted by the contact head 4. The power supply facility is connected to a roof of the vehicle 1 via a base 8 to which the first pivot arm 2 and the return apparatus 15 are rotatably coupled.

The exemplary third embodiment of an inventive power supply facility is similar to the first embodiment of an inventive power supply facility, as is shown in FIG. 1. Therefore, partially the same reference numerals as in FIG. 1 are used in FIG. 3.

FIG. 4 shows a schematic side elevation of the exemplary third embodiment of an inventive power supply facility in a lowered position, which, in the deflected position, is also shown in FIG. 3. Therefore, partially the same reference numerals as in FIG. 3 are used in FIG. 4.

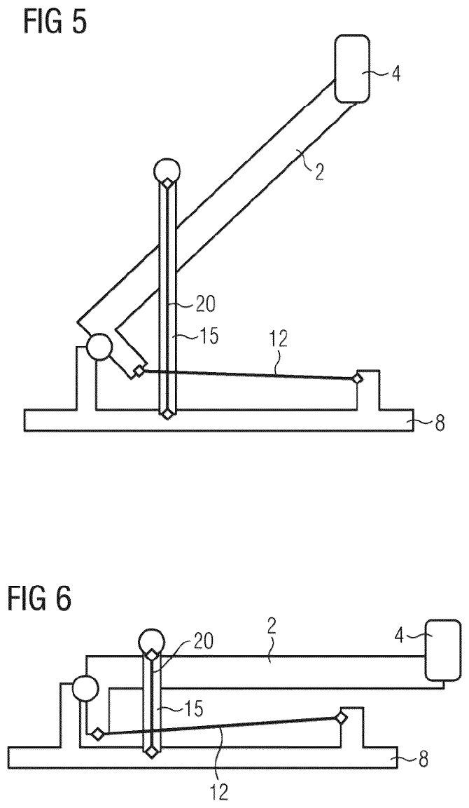

FIG. 5 shows a schematic side elevation of an exemplary fourth embodiment of an inventive power supply facility in a deflected position with a first pivot arm 2, a contact head 4 and a return apparatus 15 displaceably mounted in the direction of a power supply facility vertical axis 11, as represented, by way of example, in FIG. 1. This exemplary fourth embodiment is similar to the exemplary third embodiment of an inventive power supply facility, as shown in FIG. 3. Therefore, partially the same reference numerals as in FIG. 3 are used in FIG. 5.

In contrast to FIG. 3, FIG. 5 shows a return apparatus 15 that can execute only translational movements. Therefore, for the exemplary fourth embodiment of an inventive power supply facility, no force-torque converter is required between a return drive 20 and the return apparatus 15.

FIG. 6 represents a schematic side elevation of the exemplary fourth embodiment of an inventive power supply facility in a lowered position which, in the deflected position, is also shown in FIG. 5. Therefore, the same reference numerals as in FIG. 5 are used in FIG. 6.

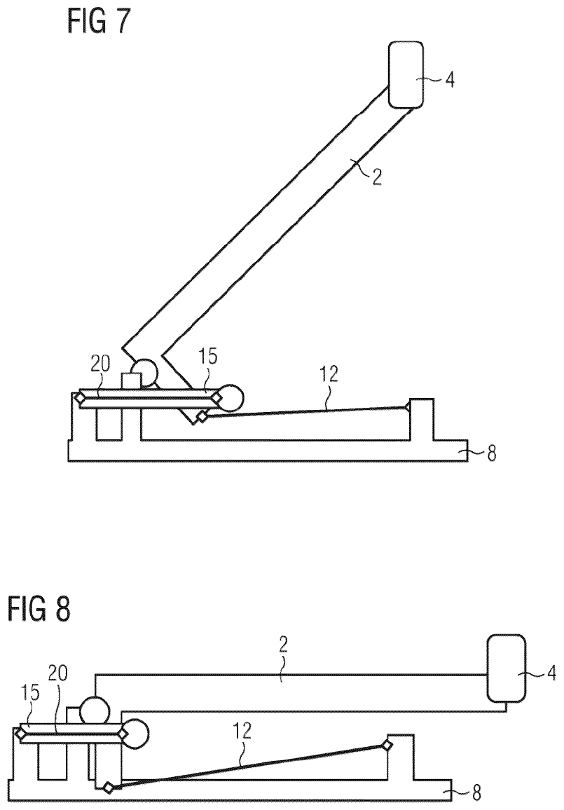

FIG. 7 represents a schematic side elevation of an exemplary fifth embodiment of an inventive power supply facility in a deflected position with a first pivot arm 2, a contact head 4 and a return apparatus 15 displaceably mounted in the direction of a power supply facility longitudinal axis 10, as shown, by way of example, in FIG. 1.

This exemplary fifth embodiment is similar to the exemplary fourth embodiment of an inventive power supply facility, as shown in FIG. 5. Therefore, the same reference numerals as in FIG. 5 are used in FIG. 7.

In contrast to FIG. 5, the return apparatus 15 according to FIG. 7 is not displaceable in the direction of a power supply facility vertical axis 11 shown, by way of example, in FIG. 1, but rather in the direction of the power supply facility longitudinal axis 10.

FIG. 8 shows a schematic side elevation of the exemplary fifth embodiment of an inventive power supply facility in a lowered position, which, in the deflected position, is also shown in FIG. 7. Therefore, the same reference numerals as in FIG. 7 are used in FIG. 8.

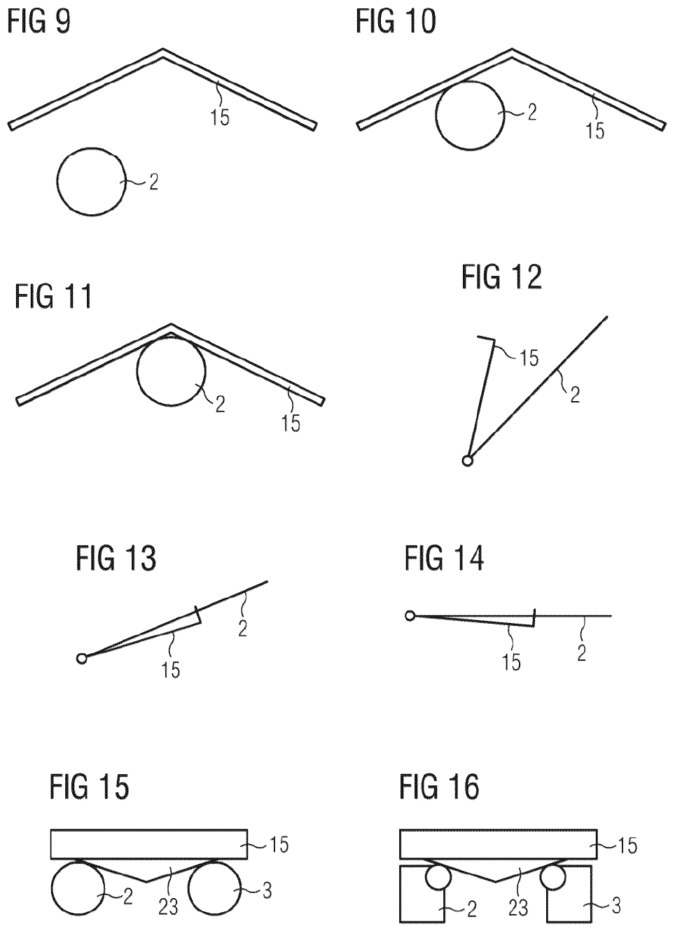

FIG. 9, FIG. 10, FIG. 11, FIG. 12, FIG. 13 and FIG. 14 show schematic representations of different relative positions of a first pivot arm 2 and a return apparatus 15 of an exemplary sixth embodiment of an inventive power supply facility, with cross-sections of the first pivot arm 2 being represented in FIG. 9, FIG. 10 and FIG. 11, in contrast to FIG. 12, FIG. 13 and FIG. 14.

FIG. 9 and FIG. 12 show a deflected position of the first pivot arm 2, as is also represented, by way of example, in FIG. 3, and in which the return apparatus 15 is spaced apart from the first pivot arm 2.

FIG. 10 and FIG. 13 show a transition position of the first pivot arm 2, between the deflected position and a lowered position of the first pivot arm 2, with the return apparatus 15 being applied in the transition position to the first pivot arm 2, but the first pivot arm 2 not yet being centered in the return apparatus 15. During further movement of the first pivot arm 2 and the return apparatus 15, the first pivot arm 2 is centered in the direction of the lowered position in the return apparatus 15.

FIG. 11 and FIG. 14 show a lowered position of the first pivot arm 2, as is also represented, by way of example, in FIG. 2 and in which the return apparatus 15 is applied to the first pivot arm 2. The first pivot arm 2 is centered in the return apparatus 15 in this lowered position.

FIG. 15 shows a schematic detail from an exemplary eighth embodiment of an inventive power supply facility, in which a wear-resistant, triangular sliding element 23 is arranged between a first pivot arm 2 and a second pivot arm 3 on the one hand and a return apparatus 15 on the other hand.

FIG. 16 shows a schematic detail from an exemplary ninth embodiment of an inventive power supply facility, in which a wear-resistant, triangular sliding element 23 is arranged between rounded regions of a first pivot arm 2 and a second pivot arm 3, on the one hand, and a return apparatus 15 on the other hand.

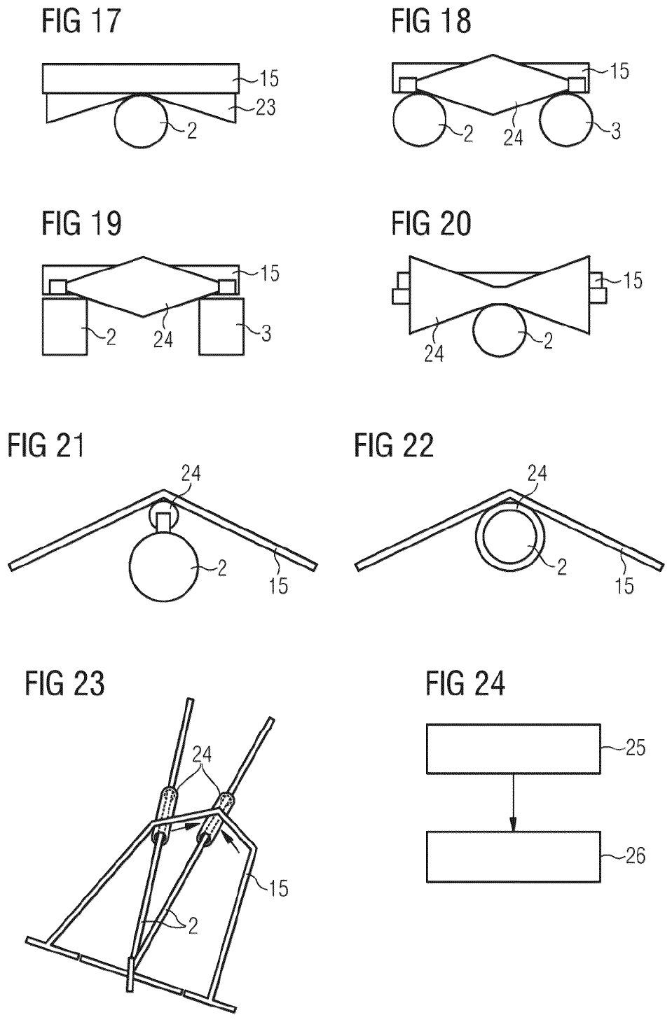

FIG. 17 shows a schematic detail from an exemplary tenth embodiment of an inventive power supply facility, in which a wear-resistant sliding element 23, which is formed as a centering apparatus and has a triangular notch, is arranged between a first pivot arm 2 and a return apparatus 15.

FIG. 18 shows a schematic detail from an exemplary eleventh embodiment of an inventive power supply facility, in which a double conical roller 24 is arranged between a first pivot arm 2 and a second pivot arm 3, on the one hand, and a return apparatus 15, on the other hand, in which roller the apexes face away from one another.

FIG. 19 shows a schematic detail from an exemplary twelfth embodiment of an inventive power supply facility, in which a double-conical roller 24 is arranged between a first pivot arm 2 and a second pivot arm 3, on the one hand, and a return apparatus 15, on the other hand, in which roller 24 the apexes face away from one another.

FIG. 20 shows a schematic detail from an exemplary thirteenth embodiment of an inventive power supply facility, in which a double-conical roller 24 formed as a centering apparatus is arranged between a first pivot arm 2 and a return apparatus 15, with apexes facing each other, where the roller 24 forms a receptacle for the first pivot arm 2.

FIG. 21 shows a schematic detail from an exemplary fourteenth embodiment of an inventive power supply facility, in which a roller 24 rotatably connected to a circumference of the first pivot arm 2 is arranged between a first pivot arm 2 and a return apparatus 15, which roller 24 contacts the return apparatus 15 in the state shown in FIG. 21.

FIG. 22 shows a schematic detail from an exemplary fifteenth embodiment of an inventive power supply facility, in which a roller 24 is arranged between a first pivot arm 2 and a return apparatus 15 so as to rotatably surround the first pivot arm 2, which roller 24 contacts the return apparatus 15 in the state shown in FIG. 22.

FIG. 23 discloses a schematic detail of an exemplary sixteenth embodiment of an inventive power supply facility, in which a roller 24 is arranged between a first pivot arm 2 and a return apparatus 15 so as to rotatably surround the first pivot arm 2, with the first pivot arm 2 being spaced apart from the return apparatus 15 in a first state of the power supply facility, and the first pivot arm 2 contacting the return apparatus 15 and being centered in respect of the return apparatus 15 in a second state of the power supply facility.

FIG. 24 is a flowchart for an exemplary embodiment of an inventive method for returning a first pivot arm 2 of a current collector shown, by way of example, in FIG. 1. The current collector acts as a power supply facility, as is shown, by way of example, in FIG. 1. The current collector is configured for an electric bus, i.e., for a utility vehicle.

A contact head 4, likewise shown, by way of example, in FIG. 1, is connected by the first pivot arm 2 to the current collector. The current collector also comprises a return apparatus 15, as is likewise represented, by way of example, in FIG. 1.

In accordance with the method, starting from a completely deflected first state of the first pivot arm 2, in which the return apparatus 15 is spaced apart from the first pivot arm 2, the return apparatus 15 is pressed against the first pivot arm 2 (pressing process 25) and the first pivot arm 2 is guided into a lowered and centered second state of the first pivot arm 2 (driving process 26), where the return apparatus 15 is pressed against the first pivot arm 2 in the second state.

Inventively, it is also possible for the return device 15 to be pressed against the first pivot arm 2, for example, starting from a partially deflected state of the first pivot arm 2, and for the first pivot arm 2 to be guided into the lowered and centered second state.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A power supply facility for a vehicle, comprising:
at least one contact head which is movable so as to contact a docking apparatus to form an electrical connection;
at least one first pivot arm which is connected to the at least one contact head and which is rotatably connected to a vehicle; and
a return apparatus;
wherein the return apparatus is formed as a driver with respect to the at least first pivot arm and is appliable to the at least first pivot arm and removable from the at least first pivot arm.

17. The power supply facility as claimed in claim 16, wherein the return apparatus is bow-shaped or hook-shaped.

18. The power supply facility as claimed in claim 17, wherein the return apparatus has a first leg and a second leg, which are oriented towards one another in an inclined manner.

19. The power supply facility as claimed in claim 16, wherein the at least first pivot arm is connectable to a vehicle so as to be rotatable about a parallel to a power supply facility transverse axis and about a normal to the parallel to the power supply facility transverse axis.

20. The power supply facility as claimed in claim 17, wherein the at least first pivot arm is connectable to a vehicle so as to rotate about a parallel to a power supply facility transverse axis and about a normal to the parallel to the power supply facility transverse axis.

21. The power supply facility as claimed in claim 18, wherein the at least first pivot arm is connectable to a vehicle so as to be rotatable about a parallel to a power supply facility transverse axis and about a normal to the parallel to the power supply facility transverse axis.

22. The power supply facility as claimed in claim 16, wherein the return apparatus is connectable to a vehicle so as to rotate about a parallel to a power supply facility transverse axis.

23. The power supply facility as claimed in claim 16, wherein the return apparatus is connectable to a vehicle in a displaceable manner in a direction of at least one of a power supply facility longitudinal axis and a power supply facility vertical axis.

24. The power supply facility as claimed in claim 16, wherein the return apparatus is coupled to its own return drive.

25. The power supply facility as claimed in claim 16, further comprising:
at least one sliding element or a sliding layer arranged between the at least first pivot arm and the return apparatus.

26. The power supply facility as claimed in claim 25, wherein the at least one sliding element or the sliding layer is formed as a centering apparatus for the at least first pivot arm.

27. The power supply facility as claimed in claim 16, further comprising:
at least one roller or at least one roll arranged between the at least first pivot arm and the return apparatus.

28. The power supply facility as claimed in claim 27, wherein the at least one roller or the at least one roll is formed as a centering apparatus for the at least first pivot arm.

29. The power supply facility as claimed in claim 16, further comprising:
at least one first return spring for generating a spring force, via which the at least first pivot arm is guidable automatically in the direction of a vehicle, connected to the return apparatus.

30. The power supply facility as claimed in claim 16, wherein the vehicle comprises a utility vehicle.

31. The power supply facility as claimed in claim 30, wherein the utility vehicle comprises an electric bus or an electric truck.

32. A power supply arrangement for a vehicle including the at least one power supply facility as claimed in claim 16 and including at least one stationary, electrical charging apparatus comprising at least one docking apparatus, with which the at least one power supply facility is brought into contact with electricity to form an electrical connection and to supply the at least one power supply facility.

33. The power supply arrangement as claimed in claim 32, wherein the vehicle comprises a utility vehicle.

34. The power supply arrangement as claimed in claim 33, wherein the utility vehicle comprises an electric bus or an electric truck.

35. A vehicle including the at least one power supply facility as claimed in claim 16.

36. The vehicle as claimed in claim 35, wherein the vehicle comprises a utility vehicle.

37. The vehicle as claimed in claim 36, wherein the utility vehicle comprises an electric bus or an electric truck.

38. A method for returning a first pivot arm with which a contact head is connected to a current collector for a vehicle, the current collector comprising a return apparatus, the method comprising:
starting from a completely deflected first state of the first pivot arm, in which the return apparatus is spaced apart from the first pivot arm, pressing the return apparatus against the first pivot arm; and
guiding the first pivot arm into a lowered and centered second state of the first pivot arm;
wherein the return apparatus is pressed against the first pivot arm in the second state.

39. The method as claimed in claim 38, wherein the vehicle comprises a utility vehicle.

40. The method as claimed in claim 39, wherein the utility vehicle comprises an electric bus or an electric truck.
